(19) United States
(12) Patent Application Publication
(10) Pub. No.: US 2013/0000561 A1
(43) Pub. Date: Jan. 3, 2013

(54) INTERMITTED HYPOXIC TRAINING FACILITY AND METHOD FOR ANIMALS

(76) Inventors: Andrew D. Park, Lessburg, VA (US); Cecilia J Kim Park, Lessburg, VA (US)

(21) Appl. No.: 13/518,637

(22) PCT Filed: Dec. 22, 2010
(86) PCT No.: PCT/US2010/003235

§ 371 Date: Jun. 22, 2012

Related U.S. Application Data
(60) Provisional application No. 61/284,734, filed on Dec. 23, 2009.
(60) Provisional application No. 61/335,019, filed on Dec. 30, 2009.

(51) Int. Cl. A01K 1/03; A61B 5/024; A01K 15/02

(52) U.S. Cl. 119/420; 600/508

(57) ABSTRACT

A hypoxic training facility includes a plurality of walls defining an enclosure for housing an animal to be trained. A hypoxicator is adapted for delivering hypoxic, hyperoxic, and normoxic air to the enclosure during a hypoxic training session. An animal exercise station is located within the enclosure. A pulse oximeter monitors oxygen saturation of the animal's blood during the hypoxic training session. A computing device calculates hypoxic stress delivered to the animal during the hypoxic training session.

### TECHNICAL FIELD AND BACKGROUND OF THE INVENTION

This invention relates generally an intermitted hypoxic training facility and method for animals, such as racehorses, racing dogs, livestock, and the like. In one exemplary implementation, an aim of the present training (or hypoxic therapy) conducted according to this disclosure is to obtain benefits in physical performance and well-being of certain animals through improved oxygen metabolism. When an animal is exposed to hypoxia (oxygen reduced environments), it struggles to produce required amounts of energy with less available oxygen. This struggle is presumed to trigger an onset of a range of physiological adaptations geared towards enhancing the efficiency of the animal's respiratory, cardiovascular and oxygen utilization systems.

### SUMMARY OF EXEMPLARY EMBODIMENTS

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

According to one exemplary embodiment, the present disclosure comprises a hypoxic training facility for animals. The hypoxic training facility includes a plurality of walls defining an enclosure (e.g., controllable environment) for housing an animal to be trained. A hypoxicator is adapted for delivering hypoxic, hyperoxic, and normoxic air to the enclosure during a hypoxic training session. An animal exercise station is located within the enclosure. Means are provided for monitoring oxygen saturation of the animal's blood during the hypoxic training session. Means are provided for calculating hypoxic stress delivered to the animal during the hypoxic training session.

The term “hypoxic training” refers broadly to performance training, rehabilitative training, and therapeutic training for the general well-being of the animal.

According to another exemplary embodiment, the means for calculating hypoxic stress comprise means utilizing a computing device for calculating a Hypoxic Training index (HTi).

According to another exemplary embodiment, the means for monitoring oxygen saturation comprise a pulse oximeter.

According to another exemplary embodiment, the hypoxicator comprises a biofeedback controller adapted for automatically adjusting oxygen concentration within the enclosure during the hypoxic training session.

According to another exemplary embodiment, an air conditioning device communicates with the enclosure.

According to another exemplary embodiment, the air conditioning device comprises a heat pump to heat and cool the enclosure.

According to another exemplary embodiment, a thermostat is operatively connected to the air conditioning device for regulating a temperature within the enclosure.

According to another exemplary embodiment, means are provided for remotely monitoring temperature within the enclosure and remotely controlling the thermostat.

According to another exemplary embodiment, a heart rate monitor is adapted for monitoring a heart rate of the animal during the hypoxic training session.

According to another exemplary embodiment, means are provided for communicating real-time facility data to a remote terminal. Examples of remote terminals include desktop PCs, laptop computers, handheld wireless computers, mobile or cellular phones, Smartphones, and other related computing devices. The real-time facility data is selected from a group consisting of oxygen concentration within the enclosure, temperature within the enclosure, oxygen saturation of the animal's blood, and hypoxic stress delivered to the animal.

According to another exemplary embodiment, means are provided for remotely monitoring and remotely controlling a plurality of electronic devices adapted for receiving and transmitting facility data.

According to another exemplary embodiment, the electronic devices are selected from a group consisting of a video camera mounted within the enclosure, a thermostat, and entryway.

According to another exemplary embodiment, the animal exercise station comprises an equine treadmill.

According to another exemplary embodiment, means are provided for remotely monitoring and remotely controlling the hypoxicator and equine treadmill.

In another exemplary embodiment, the present disclosure comprises a building incorporating a plurality of hypoxic training facilities for animals as described herein.

In yet another exemplary embodiment, the present disclosure comprises a method for improving performance (and/or wellbeing) of a competition animal. The method includes housing the animal within an enclosure of a hypoxic training facility, and delivering hypoxic, hyperoxic, and normoxic air to the enclosure during a hypoxic training session. During the hypoxic training session, the animal is exercised within the enclosure. Oxygen saturation of the animal's blood and hypoxic stress delivered to the animal are monitored during the hypoxic training session.

According to another exemplary embodiment, the method includes delivering hypoxic air to the enclosure in an intermitted manner.

According to another exemplary embodiment, the method includes remotely monitoring and remotely controlling the delivery of hypoxic, hyperoxic, and normoxic air to the enclosure.

According to another exemplary embodiment, the method includes remotely monitoring and remotely controlling an animal exercise station within the enclosure.

According to another exemplary embodiment, the method includes remotely monitoring and remotely controlling a temperature within the enclosure.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is an environmental view showing multiple modular hypoxic training facilities incorporated in covered racehorse stable;

FIG. 2 is an exploded view of an exemplary module enclosure of the present training facility;

FIG. 3 is a schematic view illustrating the delivery of hypoxic air to one or more of the modular training facilities; and

FIG. 4 is a further schematic view illustrating the remote monitoring and control functionality of the present disclosure.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

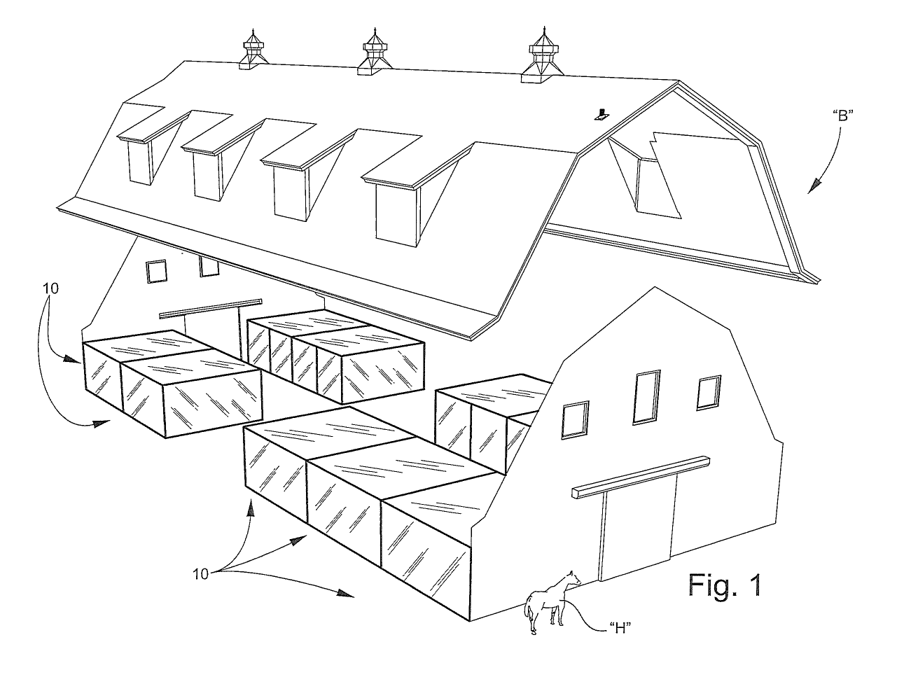

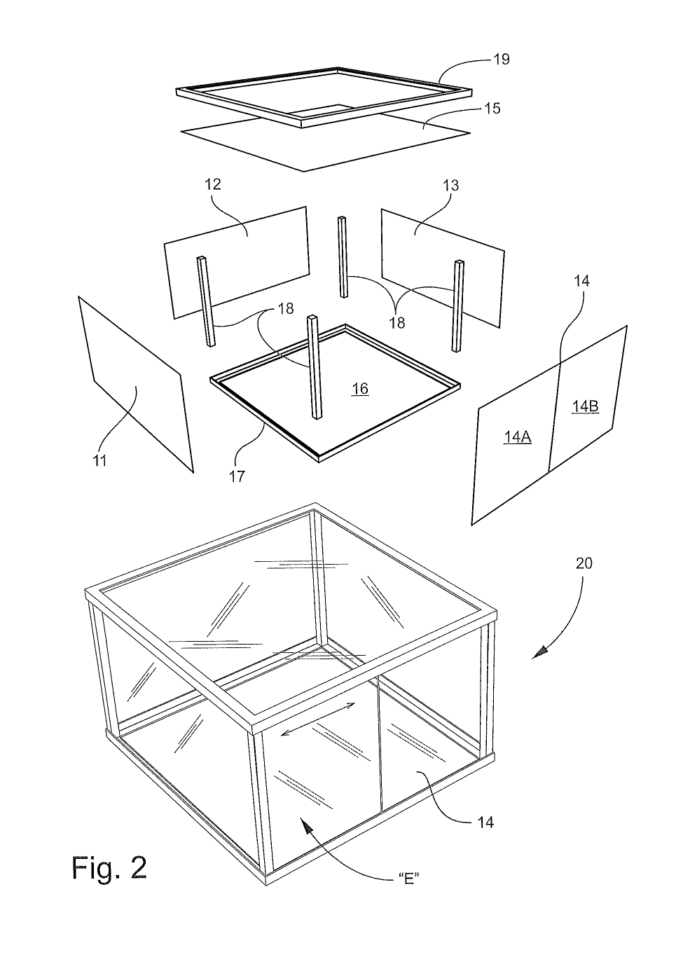

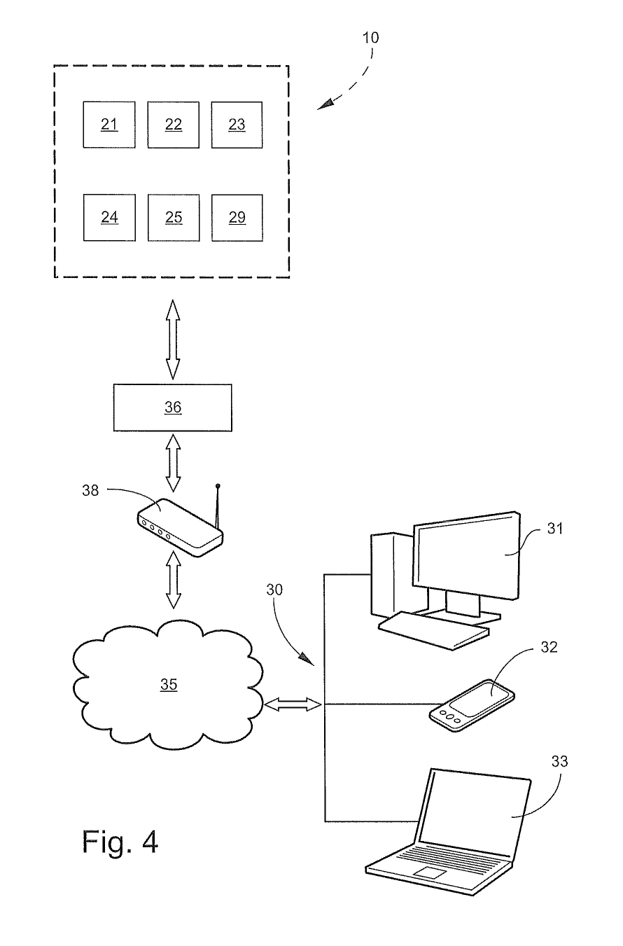

Referring now specifically to the drawings, a hypoxic training facility for animals is shown in FIG. 1, and indicated broadly and generally at reference numeral 10. In the exemplary embodiment, the training facility 10 is located with a number of like modular facilities within a building “B”, such a covered horse stable suitable for keeping and training racehorses. As shown in FIG. 2, each facility 10 is defined by joined walls 11, 12, 13, 14, 15, and 16, and rigid floor, wall, and ceiling framing 17, 18, and 19 to form a modular enclosure 20. The walls 11-16 may be constructed of thin, transparent pre-fabricated panels comprising a lightweight material, such as Lucite (RTM) or other acrylic resin or plastic, Plexiglas (RTM), glass, flexible thermoplastic, or combinations of these materials. At least one wall 14 may comprise an entryway “E” for access to an inside of the enclosure 20. The entryway “E” may be formed by one or two side-by-side sliding wall sections 14A, 14B. Alternatively, a more conventional hinged access door (not shown) may be provided. In either case, the entryway “E” may be secured using a electronic door lock 21 (see FIG. 4), such as that manufactured by Schlage Lock Company of Carmel, Ill. The enclosure 20 may be readily and conveniently disassembled, transported, and reassembled. The exemplary enclosure 20 is approximately 12′×12′ with a 9′ flexible (e.g., thermoplastic) ceiling 15.

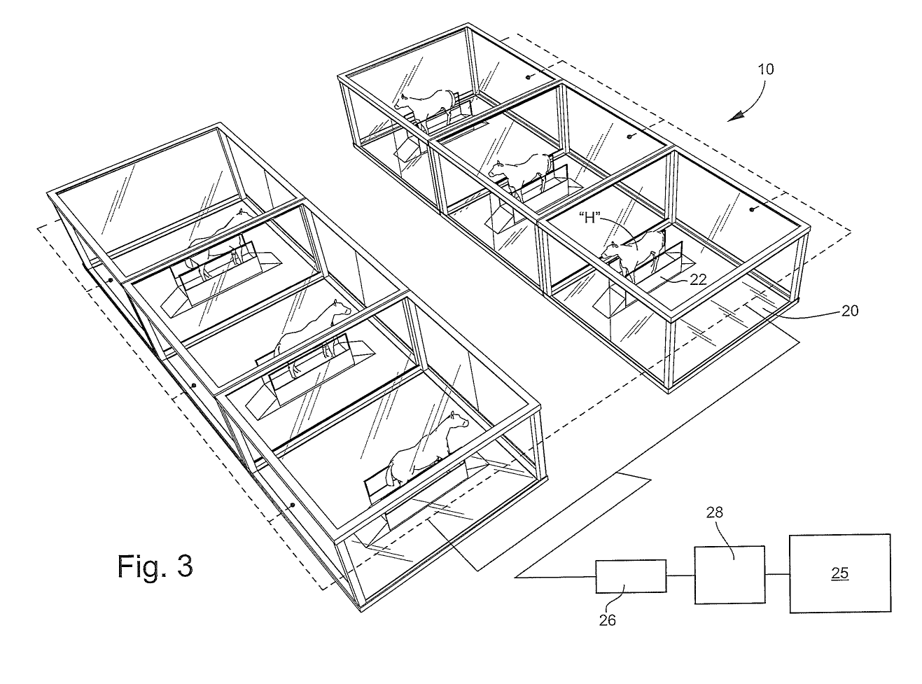

As shown in FIG. 3, each hypoxic training facility 10 utilizes an equine treadmill 22 for conditioning a racehorse “H” during an intermitted hypoxic training (IHT) session, discussed further below. The exemplary treadmill 22 comprises a wide moving belt, and has variable speed and incline capabilities with adjustable intensity and duration. The treadmill belt defines a smooth, consistent training surface for the horse “H”. A wireless video camera 23 (FIG. 4) may be located within the enclosure 20 proximate the treadmill 22 for remotely observing and recording the gait of the horse “H”. With the horse “H” being relatively stationary while training, it may be possible for a trainer at a remote site to detect irregularities in gait for lameness problems, or to evaluate improvements in horses recovering from injuries. Additionally, a combined battery-operated heart rate monitor/pulse oximeter 24 (FIG. 4) may be suitably attached to the horse “H” (e.g., at ear, nasal septum, or tongue) for monitoring the heart rate and oxygen saturation of the horse's blood during the IHT session. One example of pulse oximeter 24 suitable for animals is described in prior U.S. Pat. No. 5,800,349 entitled “Offset pulse oximeter sensor”, the complete disclosure of which is incorporated herein by reference. The pulse oximeter 24 measures SpO2 and pulse rate, and may comprise a veterinary specific SpO2 sensor to accommodate variety of species.

In other implementations, one or more of the hypoxic training facilities 10 may utilizes other animal exercising devices, such as a submerged treadmill system. Generally, such systems comprise an engineered combination of a submerged treadmill and whirlpool/swimming pool.

In one exemplary embodiment, a single hypoxicator 25 communicates with the hypoxic training facilities 10 through appropriate conduits, ducts, and/or piping, and functions to deliver hypoxic, hyperoxic, and normoxic air to one or more selected enclosures 20 during a hypoxic training session. The exemplary hypoxicator 25 may comprise an air separation system employing semi-permeable membrane technology or pressure swing adsorption (PSAS). Prior to delivery, oxygen-depleted (or hyperoxic or normoxic) air may be cleaned by a HEPA filter 26 or other filtering means, and may be heated or cooled by an optional air conditioning device 28, such as a heat pump. A remote-control thermostat 29 (FIG. 4) may be provided for each training facility 10, and operatively connected to the air conditioning device 28 to regulate air temperature within the enclosure 20.

The treatment “dosage” for each hypoxic training session can be measured and expressed as Hypoxic Training index (HTi). The exemplary hypoxicator 25 may allow automated and pre-programmed delivery of prescribed hypoxic and hyperoxic or normoxic air to the selected facility 10, and may incorporate advanced biofeedback control for safety monitoring and for automatically adjusting oxygen concentration in the air. In one implementation, the intermitted hypoxic training (IHT) is delivered to the horse “H” in an intermittent manner during periods of light, moderate and heavy activity on the equine treadmill 22. In one example, an IHT session may constitute a few minutes interval of breathing hypoxic air (e.g., 11 to 15% oxygen) alternated with an ambient or hyperoxic air over a 45- to 90-minute session per day over a 3-4 week period. In one exemplary implementation, the horse “H” undergoes the IHT session together with a trainer inside the enclosure 20. The trainer rides the horse during periods of light, moderate, and heavy activity on the equine treadmill 22 while both the trainer and horse are exposed (simultaneously) to hypoxic, hyperoxic and normoxic air.

During training, the Hypoxic Training index (HTi) can be calculated using the following formula, required inputs/data, and any suitable computing device (e.g., controller 36 discussed below):

$$HTi = 1 / 60 {\int }_{0}^{t} [ 90 - {Sp O}_{2} ( t ) ] d t$$

where:

HTi: Hypoxic Training index

t: period of time, and

SpO2 (t): SpO2 (%), arterial oxygen saturation value measured at one-second intervals.

The HTi provides an objective index (numerical figure) of the hypoxic stress on the horse “H” at the end of the training session. Knowledge of HTi can therefore be used to alter the training regime for different horses, compensating for individual variability.

### Remote Facility Monitoring and Control

Referring to FIG. 4, each training facility 10 may comprise or utilize a number of electronic facility devices (or electronically controlled devices), such as the door lock 21, equine treadmill 22, video camera 23, heart rate monitor/pulse oximeter 24, hypoxicator 25, and thermostat 29. Each facility device 21, 22, 23, 24, 25, and 29 incorporates an RF transceiver operating within a RF mesh network adapted for transmitting and receiving facility data to and from a remote computer terminal 30, such as desktop PC 31, handheld wireless device 32, and/or laptop computer 33. The RF mesh network may be coupled to the remote terminal 30 via a global communications network 35, such as the Internet. One example of RF electronic devices operating within a RF mesh network is described in prior published U.S. Patent Application Publication No. 2010/0283579 published on Nov. 11, 2010 and owned by Schlage Lock Company of Carmel, Ind. USA. The complete disclosure of this publication is incorporated herein by reference.

In the present exemplary embodiment, a system controller 36 or “gateway device” includes a central processing unit for calculating HTi and carrying out other computer programs and functions, a RF transceiver for sending and receiving RF signals to and from the RF facility devices in the mesh network, an Internet Protocol (IP) transceiver for communicating with the global network 35, a memory unit, and power source (e.g., battery). The IP transceiver formats the signals it sends according to the communications protocol, e.g. Internet Protocol, and may connect to a wireless router 38 using a wireless connection, for example using an IEEE 802.11x-based wireless networking protocol. In one embodiment, the controller 36 may act as a server (e.g., web server) that can be directly accessed and controlled by the remote user terminal 30. In other embodiments, a separate networked computer server (not shown) may comprise a web server that communicates with the remote user terminal 30 using HyperText Transfer Protocol (HTTP) commands or other protocols suited for use via the Internet 35, with appropriate web-browsing or other software being loaded on the remote terminal 30.

The exemplary RF facility devices 21, 22, 23, 24, 25, and 29 may communicate real-time facility data and information according to the Z-WAVE bi-directional communication protocol described in prior U.S. Pat. No. 6,980,080. The complete disclosure of this prior patent is incorporated herein by reference. As part of its implementation of the mesh network, the Z-WAVE protocol includes procedures for routing of commands between networked devices to the correct final destination. Z-WAVE uses a two-way RF system that operates in the 908 MHz band in the United States. Examples of real-time facility data communicated via the present RF mesh network include oxygen concentration within the facility enclosure, temperature within enclosure, oxygen saturation of the horse's blood, and the hypoxic stress delivered to the horse during training. This and other facility data may be communicated to any of the above-listed remote terminals 30 for 24/7 real-time monitoring of each hypoxic training facility 10. Any one or more of RF facility devices within the mesh network can also be remotely controlled in real-time (and 24/7) via commands entered by the user utilizes any of the exemplary remote terminals 30. For example, from his desktop computer 31 at virtually any location in the world the remote user (e.g, horse trainer) can enter commands to activate or deactivate the door lock 21, can enter commands to control and adjust the equine treadmill 22, can enter commands to activate and control the video camera 23 to visually observe the horse's gait, can get instant continuous readings of pulse rate and blood-oxygen saturation levels of the horse (via pulse oximeter 24) during training, can enter commands to control the hypoxicator 25 to adjust oxygen concentration within the enclosure, and can enter commands to control the thermostat 29. The above is provided by way of example only—it being understood that the present RF mesh network may comprise any number of other RF facility devices adapted for remote monitoring and control.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

What is claimed:

1. A hypoxic training facility for animals, comprising:
a plurality of walls defining an enclosure for housing an animal to be trained;
a hypoxicator adapted for delivering hypoxic, hyperoxic, and normoxic air to said enclosure during a hypoxic training session;
an animal exercise station within said enclosure;
means for monitoring oxygen saturation of the animal's blood during the hypoxic training session; and
means for calculating hypoxic stress delivered to the animal during the hypoxic training session.

2. A hypoxic training facility for animals according to claim 1, wherein said means for calculating hypoxic stress comprises means utilizing a computing device for calculating a Hypoxic Training index (HTi).

3. A hypoxic training facility for animals according to claim 1, wherein said means for monitoring oxygen saturation comprises a pulse oximeter.

4. A hypoxic training facility for animals according to claim 1, wherein said hypoxicator comprises a biofeedback controller adapted for automatically adjusting oxygen concentration within said enclosure during the hypoxic training session.

5. A hypoxic training facility for animals according to claim 1, and comprising an air conditioning device communicating with said enclosure.

6. A hypoxic training facility for animals according to claim 5, wherein said air conditioning device comprises a heat pump to heat and cool said enclosure

7. A hypoxic training facility for animals according to claim 5, and comprising a thermostat operatively connected to said air conditioning device for regulating a temperature within said enclosure.

8. A hypoxic training facility for animals according to claim 7, and comprising means for remotely monitoring temperature within said enclosure and remotely controlling said thermostat.

9. A hypoxic training facility for animals according to claim 1, and comprising a heart rate monitor adapted for monitoring a heart rate of the animal during the hypoxic training session.

10. A hypoxic training facility for animals according to claim 1, and comprising means for communicating real-time facility data to a remote terminal, said real-time facility data selected from a group consisting of oxygen concentration within said enclosure, temperature within said enclosure, oxygen saturation of the animal's blood, and hypoxic stress delivered to the animal.

11. A hypoxic training facility for animals according to claim 1, and comprising means for remotely monitoring and remotely controlling a plurality of electronic devices adapted for receiving and transmitting facility data.

12. A hypoxic training facility for animals according to claim 11, wherein said electronic devices are selected from a group consisting of a video camera mounted within said enclosure, thermostat, and door lock.

13. A hypoxic training facility for animals according to claim 1, wherein said animal exercise station comprises an equine treadmill.

14. A hypoxic training facility for animals according to claim 13, and comprising means for remotely monitoring and remotely controlling said hypoxicator and said equine treadmill.

15. A building comprising a plurality of hypoxic training facilities for animals, each of said hypoxic training facilities comprising:
a plurality of walls defining an enclosure for housing an animal to be trained;
a hypoxicator adapted for delivering hypoxic, hyperoxic, and normoxic air to said enclosure during a hypoxic training session;
an animal exercise station within said enclosure;
means for monitoring oxygen saturation of the animal's blood during the hypoxic training session; and
means for calculating hypoxic stress delivered to the animal during the hypoxic training session.

16. A method for improving performance of a competition animal, said method comprising:
housing the animal within an enclosure of a hypoxic training facility;
delivering hypoxic, hyperoxic, and normoxic air to the enclosure during a hypoxic training session;
exercising the animal within the enclosure;
monitoring oxygen saturation of the animal's blood during the hypoxic training session; and
calculating hypoxic stress delivered to the animal during the hypoxic training session.

17. A method according to claim 16, and comprising delivering hypoxic air to the enclosure in an intermitted manner.

18. A method according to claim 16, and comprising remotely monitoring and remotely controlling the delivery of hypoxic, hyperoxic, and normoxic air to the enclosure.

19. A method according to claim 16, and comprising remotely controlling a facility device selected from a group consisting of an equine treadmill within the enclosure, a thermostat for regulating air temperature within the enclosure, a video camera mounted within the enclosure, and an entryway lock.

20. A method according to claim 16, wherein the animal comprises a horse, and the method further comprises a trainer riding the horse during the hypoxic training session within the enclosure.
